(19) United States
(12) Patent Application Publication
(10) Pub. No.: US 2025/0284036 A1
(43) Pub. Date: Sep. 11, 2025

(54) GRADIENT-INDEX LENS AND METHOD OF MANUFACTURING

(71) Applicant: HUAWEI TECHNOLOGIES CO., LTD., Shenzhen (CN)

(72) Inventors: Alejandro MURILLO BARRERA, Munich (DE); Anastasios PARASKEVOPOULOS, Siena (IT); Stefano MACI, Siena (IT); Bruno BISCONTINI, Munich (DE); Francesca MAGGIORELLI, Siena (IT)

(21) Appl. No.: 19/220,352

(22) Filed: May 28, 2025

Related U.S. Application Data
(63) Continuation of application No. PCT/EP2022/083680, filed on Nov. 29, 2022.

(51) Int. Cl. G02B 3/00; B29D 11/00; G02B 3/06

(52) U.S. Cl. CPC G02B 3/0087; B29D 11/00355; G02B 3/06; B29K 2995/0006

(57) ABSTRACT

A gradient-index lens for shaping one or more microwave beams, comprising a primary lens and one or more secondary lenses. The primary lens comprises a cylinder of dielectric material, with a cutout on a lateral surface of the cylinder. Each of the one or more secondary lenses comprises a slab of dielectric material that extends radially from the primary lens within the cutout. The primary lens and each of the secondary lenses have the same dielectric constant at a point of connection of the central region of the slab of the secondary lens with the primary lens. The gradient-index lens provides for wide angle scanning while maintaining a high gain radiation pattern without suffering from a scan loss effect.

### CROSS-REFERENCE TO RELATED APPLICATIONS

This application is a continuation of International Application No. PCT/EP2022/083680, filed on Nov. 29, 2022, the disclosure of which is hereby incorporated by reference in its entirety.

### TECHNICAL FIELD

This disclosure generally relates to antenna systems, and in particular, to a gradient-index lens for shaping one or more microwave beams and to a method of manufacturing the gradient-index lens.

### BACKGROUND

With the development of new wireless communication technologies, there is a growing demand to improve key performance indicators (KPIs) of microwave antenna systems. The key performance indicators, such as directivity, gain, front-to-back ratio (FBR), coupling, and beamwidth, are related to various parameters (e.g., electrical length, size, and efficiency) of an antenna used in the antenna system. In addition, multi-beam antenna solutions are growing in demand because of their flexible structure as compared to dynamic beam-forming systems.

In general, due to the high directivity of each beam, the radiation pattern of a multi-beam antenna allows higher transmission power to multiple devices of user equipment (UEs). However, conventional antenna systems are often fed by bulky and lossy feeding networks. They can also suffer from strong scanning losses when the beams point away from boresight, which results in an azimuth-dependent performance of the antenna systems. Further, conventional antenna systems use lenses with circular symmetry, which results in a complex structure with poorly matched feeding. Moreover, the feed port of such lenses is sub-optimal and possesses single linear polarization, which results in disturbed scanning angle scanning as well as low gain radiation pattern.

### SUMMARY

The inventors have identified the aforementioned drawbacks associated with the antenna systems. The present disclosure aims at improving the gain and the radiation pattern of lens-based antenna systems and at reducing the scan loss effect.

The present disclosure provides a gradient-index lens for transmitting one or more microwave beams and a method of manufacturing the gradient-index lens. The present disclosure provides a solution to the existing problem related to the gain and the radiation pattern of lens-based antenna systems due to scan loss effects. An embodiment of the present disclosure is to provide a solution that overcomes at least partially the problems encountered in the prior art and provides an improved gradient-index lens for transmitting one or more microwaves and an improved method of manufacturing lens.

One or more embodiments of the present disclosure are achieved by the solutions provided in the enclosed independent claims. Advantageous embodiments of the present disclosure are further defined in the dependent claims.

In one aspect, the present disclosure provides a gradient-index lens for shaping one or more microwave beams. The gradient-index lens includes a primary lens and one or more secondary lenses. The primary lens comprises a cylinder of dielectric material. In the cylinder, the dielectric constant decreases with an increase of a radial distance from the axis of the cylinder. The cylinder has a lateral surface and a cutout on the lateral surface. The cutout has a ring-sector-shaped cross-sectional area. Thus, the cutout extends radially (i.e. in a radial direction) and axially (i.e. parallel to the axis of the cylinder). The cutout extends radially up to an inner focal radius. The cutout may extend axially over the entire height of the cylinder. Each of the one or more secondary lenses comprises a slab of dielectric material that extends radially from the primary lens within the cutout. In the slab, the dielectric constant decreases with an increase of an axial distance from a central region of the slab. The primary lens and each of the secondary lenses have the same dielectric constant at a point of connection of the central region of the secondary lens with the primary lens. In other words, the dielectric constant is spatially continuous at the point of connection of the central region of the secondary lens with the primary lens.

The gradient-index lens is a beam-shaping optical device for microwave, with wide bandwidth. “Microwave” refers to electromagnetic radiation with frequencies between 1 GHz and 100 GHz. The gradient-index lens provides wide-angle scanning while maintaining a high gain radiation pattern without suffering from the scan loss effect. The gradient-index lens includes the primary lens and the one or more secondary lenses to provide zero-focal length as well as a smooth dielectric transition between the one or more secondary lenses and the primary lens. Good impedance matching is thus achieved. In addition, circuitry is avoided, and commercially available dielectric materials with a low loss tangent can be used. Low induced losses of the gradient-index lens can therefore be achieved. The gradient-index lens supports wide bandwidth by the dielectric beamformer and is limited only by the feed radiating elements. Moreover, the input matching of the feeds of each of the secondary lens benefits from the smooth dielectric transition between different parts.

In an embodiment form, the secondary lenses are attached to the primary lens within the cutout at different azimuthal positions.

This allows the gradient-index lens to be geometrically simple.

In a further embodiment form, each of the secondary lenses is arranged to be fed with a respective microwave beam of the one or more microwave beams and to feed the respective microwave beam further to the primary lens.

This allows the gradient-index lens to be used in a transmission apparatus. Use in a reception apparatus is also possible (the microwave beams will then travel in the opposite sense compared to the transmission apparatus).

Each of the one or more microwave beams may be dual-polarized (i.e. comprise two mutually orthogonal polarizations).

Note that the gradient-index lens supports dual polarizations without additional space occupation.

In a further embodiment form, each of the secondary lenses comprises multiple axially stacked sub-lenses, wherein each sub-lens comprises an axially extending slab of dielectric material, wherein the dielectric constant in the slab has an axial gradient.

In this embodiment form, the gradient-index lens can be manufactured in one molded part, or in slices which are later stacked together and allow different heights (or different gain values).

The gradient-index lens can be used notably in a Multiple-Input/Multiple-Out (MIMO) system.

In another aspect, the present disclosure provides a method of manufacturing a gradient-index lens. The method includes providing a cylinder of dielectric material, wherein the dielectric constant in the cylinder decreases with an increase of a radial distance from the axis of the cylinder and wherein the cylinder has a cutout on a lateral surface of the cylinder. The cutout has a ring-sector-shaped cross-sectional area. The cutout thus extends radially and axially. Radially the cutout extends up to an inner focal radius. Axially the cutout may extend over the entire height of the cylinder in a vertical direction. The method further includes attaching one or more slabs of dielectric material to the cylinder such that each of the slabs extends radially from the cylinder within the cutout, wherein the dielectric constant in the slab decreases with an increase of an axial distance from a center region of the slab. Each of the one or more slabs is thus attached to the cylinder within the cutout and is aligned with the axis of the cylinder. The cylinder and each of the slabs have the same dielectric constant at a point of connection of the central region of the slab with the cylinder.

The method achieves all the advantages and technical effects of the gradient-index lens of the present disclosure.

It has to be noted that all devices, elements, circuitry, units, and means described in the present application could be implemented in the software or hardware elements or any kind of combination thereof. All operations which are performed by the various entities described in the present application as well as the functionalities described to be performed by the various entities are intended to mean that the respective entity is adapted to or configured to perform the respective operations and functionalities. Even if, in the following description of specific embodiments, a specific functionality or operation to be performed by external entities is not reflected in the description of a specific detailed element of that entity which performs that specific operation or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative embodiments construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a diagram of a gradient-index lens, in accordance with an embodiment of the present disclosure;

FIG. 2 is a diagram of a beam-forming network of a gradient-index lens, in accordance with an embodiment of the present disclosure;

FIG. 3A is a diagram of a gradient-index lens, in accordance with an embodiment of the present disclosure;

FIG. 3B is a diagram of a gradient-index lens, in accordance with an embodiment of the present disclosure;

FIG. 4 is a diagram of a beam-forming network of a gradient-index lens, in accordance with an embodiment of the present disclosure;

FIGS. 5A and 5B are graphical representations that illustrate phase and amplitude of a microwave field in a primary lens of a gradient-index lens, in accordance with different embodiments of the present disclosure;

FIGS. 5C and 5D are graphical representations that illustrate phase and amplitude of a microwave field in a secondary lens of a gradient-index lens, in accordance with different embodiments of the present disclosure; and

FIG. 6 illustrates a flow chart of a method of manufacturing a gradient-index lens, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

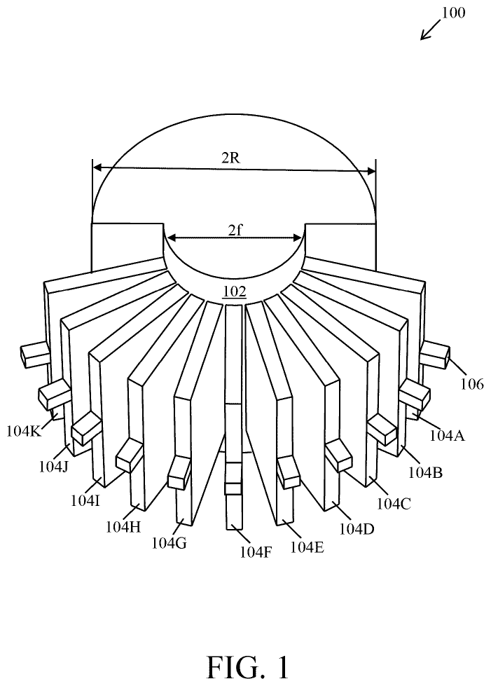

FIG. 1 is a diagram of a gradient-index lens, in accordance with an embodiment of the present disclosure. With reference to FIG. 1, there is shown a gradient-index lens 100 that includes a primary lens 102 and one or more secondary lenses 104A to 104K.

The gradient-index lens 100 can be used for microwave beam-forming with wide bandwidth and wide-angle scanning while maintaining a high gain radiation pattern without suffering from the scan loss effect. The gradient-index lens 100 provides zero-focal length, as well as the smooth dielectric transition between the one or more secondary lenses 104A to 104K and the primary lens 102 that provides effective impedance matching.

The gradient-index lens 100 includes the primary lens 102 in a form of a cylinder of dielectric material with radial gradient index. The cylinder includes a cutout on a lateral surface of the cylinder. The cutout has a ring-sector-shaped cross-sectional area. The cutout extends radially and axially. Radially it extends up to an inner focal radius. Axially it may extend over the entire height of the cylinder. In other words, the cutout on the surface of the cylinder has a shape in a cross-sectional view such that it forms cutouts of particular shape (they are ring-sector-shaped) on bases of the cylinder. In the shown example, the cutout extends axially along the entire height of the cylinder.

To emit (or receive) in a mainly horizontal direction relative to the earth, the axis of the cylinder may be oriented vertically relative to the earth. The axial direction is vertical in this case. Other orientations are also possible.

The dielectric constant of the primary lens 102 decreases with an increase of a radius of the cylinder. In an example, Gutman graded index (GRIN) material is used as the dielectric material to manufacture the primary lens 102 in the form of the cylinder, such as feeding elements of the primary lens 102 are also based on a flat GRIN lens setup, which is fully dielectric for improved impedance matching. In addition, the induced losses of the gradient-index lens 100 are low due to avoiding circuitry and the commercially available dielectric materials with low loss tangent. In an example, the cutout extends in the radial direction up to the inner focal radius that is denoted by f (i.e., half of 2f), and the radius of the cylinder is denoted by R (i.e., diameter 2R). In an embodiment, the inner focal radius is half of the radius of the cylinder. Moreover, the cutout emerges in the axial direction as a bulge-out structure from the cylinder, as shown in FIG. 1.

The gradient-index lens 100 further includes the one or more secondary lenses 104A to 104K. Moreover, each secondary lens is in a form of an axially oriented slab of dielectric material with an axial gradient index, the slab being attached as a feed to the primary lens 102 within the cutout so that the axial orientation of each of the one or more secondary lenses 104A to 104K is aligned with an axis of the cylinder. The axial gradient index provides that a dielectric constant of each of the secondary lenses decreases with an increase of a distance from a center region of the secondary lens in the axial direction. In other words, the one or more axially oriented slabs of dielectric material are attached axially withing the cutout of the primary lens 102 to form the one or more secondary lenses 104A to 104K. Moreover, the vertical orientation of each of the one or more axially oriented slabs is also aligned with the axis of the cylinder of the primary lens 102. In other words, the one or more secondary lenses 104A to 104K are attached to the primary lens 102 in such a way that each secondary lens is placed in a divergent position from another secondary lens. In an embodiment, each secondary lens includes a beam port, such as a secondary lens 104A includes a beam port 106. Similarly, other secondary lenses also include corresponding beam ports that are used to feed the corresponding secondary lens. Moreover, due to the displacement of the feeds to a zero focal length arc, the gradient-index lens 100 is compact. In addition, the overall size of the gradient-index lens 100 is reduced, such as by moving a focal arc of the feeding ports from the lens surface to inside the gradient-index lens 100. Furthermore, due to the use of the inhomogeneous permittivity material distribution, different beams are generated with reduced interference. Beneficially, as compared to conventional approaches, the gradient-index lens 100 does not require the use of electronic components and provides wide-angle scanning while maintaining a high-gain radiation pattern without suffering from the scan loss effect. In addition, the primary lens 102 and each of the secondary lenses have the same dielectric constant at a point of connection of the central region of the secondary lens with the primary lens 102. Therefore, the primary lens 102, as well as each of the secondary lenses, can be manufactured together by making the use of the structure's symmetry for assembling purposes, due to which an improved prototyping can be achieved, such as by using three-dimensional printers.

In accordance with an embodiment, the primary lens 102 and the one or more secondary lenses 104A to 104K are manufactured utilizing molding from a base material. In an embodiment, the primary lens 102 includes a molded part of the base material provided with holes in a first varying pattern to achieve the radial gradient index of the primary lens 102. In another embodiment, the primary lens 102 includes a set of axially stacked molded slices of the base material, each provided with holes in a first varying pattern to achieve the radial gradient index of the primary lens 102. In yet another embodiment, each of the secondary lenses includes a molded slab of the base material provided with holes in a second varying pattern to achieve the axial gradient index of the secondary lens.

In an embodiment, the one or more secondary lenses 104A to 104K are attached to the primary lens 102 within the cutout at different azimuthal positions. In an example, all the feeds of each of the secondary lenses are equal and manufactured by molding (e.g., via a 3D printing) and assembled at different azimuthal positions, such as the secondary lenses are attached to the primary lens 102 within the cutout at different azimuthal positions. Moreover, the cylindrical configuration of the primary lens 102 simplifies the 3D printing process of the gradient-index lens 100 in one part too. Therefore, the gradient-index lens 100 can be manufactured through a versatile and simplified manufacturing process. In an example, a radial multi-GRIN-slab beam-former is allocated on the spherical surface of the primary lens 102. In an example, a two-dimensional (2D) azimuth scanning can be obtained in dual polarization in a ±60° range without significant scan losses.

In an embodiment, the secondary lenses are fed by one or more dual-polarized sources of radiation. Therefore, the gradient-index lens 100 supports dual polarizations without additional space occupation. In an embodiment, the gradient-index lens 100 is a part of a Multiple-Input/Multiple-Out (MIMO) system, e.g. a fifth generation (5G) MIMO system. The 5G MIMO system enables improved signal range, improved spectral efficiency, and reduced power consumption. However, the gradient-index lens 100 can be used in any multi-beam antenna scenario without limiting the scope of the present disclosure, such as for sixth-generation (6G) small cells. The gradient-index lens 100 may also be applicable to any product consisting in multi-beam antennas, such as a special value for 6G cellular systems.

The gradient-index lens 100 is a beam-antenna with wide bandwidth that provides a wide-angle scanning while maintaining a high gain radiation pattern without suffering from scan loss effect. The gradient-index lens 100 includes the primary lens 102 and the one or more secondary lenses 104A to 104K to provide zero-focal length as well as the smooth dielectric transition between the one or more secondary lenses 104A to 104K and the primary lens 102 that leads to effective impedance matching. In addition, the induced losses of the gradient-index lens 100 are low due to avoiding circuitry and the commercially available dielectric materials with low loss tangent. The gradient-index lens 100 supports wide bandwidth by the dielectric beamformer and is only limited by the feed radiating elements. Moreover, the input matching of the feeds of each of the secondary lenses benefits from the smooth dielectric transition between different parts.

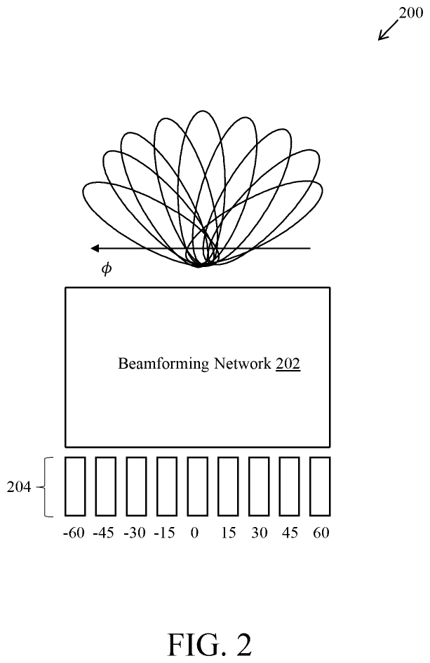

FIG. 2 schematically illustrates a beam-forming network 202 that comprises the gradient-index lens 100 described above. FIG. 2 is described in conjunction with elements from FIG. 1.

In an embodiment, the gradient-index lens 100 includes thin radial slabs, such as the one or more secondary lenses 104A to 104K, which constitute the feeding network that includes a plurality of beam ports 204, as shown in FIG. 2. The plurality of beam ports 204 are shown as per the degree of a radiation pattern that varies according to the value of theta, such as the radiation pattern includes a main beam at zero degrees and a plurality of side beams ranging from −60 to −15 degrees and +15 to +60 degrees. Moreover, the plurality of beam ports 204 of the one or more secondary lenses 104A to 104K is configured to generate different beams using the inhomogeneous permittivity material distribution. In an example, a wide bandwidth is supported by the dielectric beamformer that is only limited by the feed radiating elements of the one or more secondary lenses 104A to 104K. Furthermore, the input matching of the plurality of beam ports 204 are benefited from the smooth dielectric transition between parts. Moreover, the use of zero-focal distance feeding at an inner focal radius allows a one-part structure with a compact size. As a result, the gradient-index lens 100 supports dual polarizations without additional space occupation.

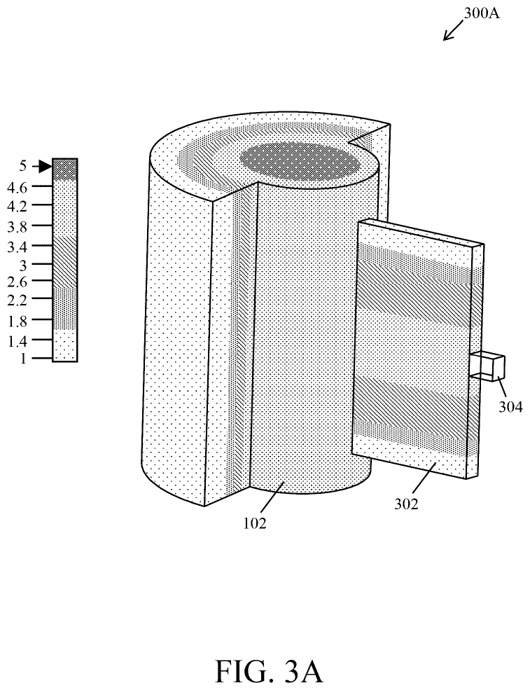

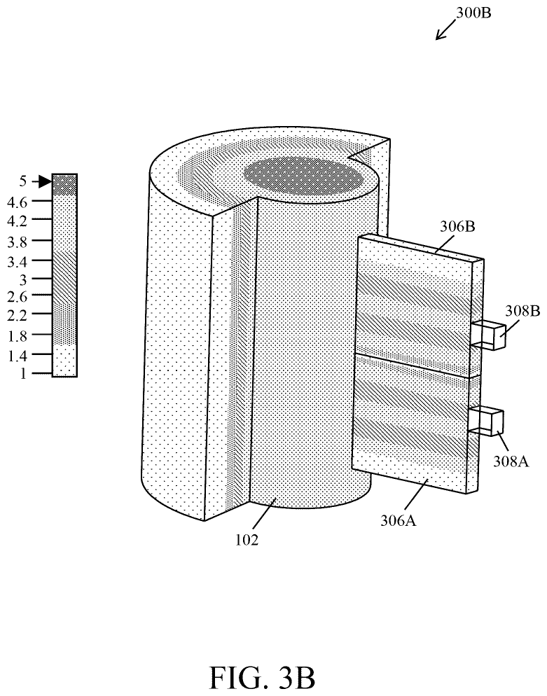

FIG. 3A is a diagram of a gradient-index lens, in accordance with an embodiment of the present disclosure. FIG. 3A is described in conjunction with elements from FIGS. 1 and 2. With reference to FIG. 3A, there is shown the gradient-index lens 100 that includes a primary lens 102 (of FIG. 1), a secondary lens 302, and a beam port 304. There is further shown a scale that represents permittivity variation ranges from 1 to 5 decibels (dB), with a step size of 0.4 dB.

In an embodiment, the overall size of the primary lens 102 is reduced by moving a focal arc of the feeding ports from the surface of the primary lens 102 to inside the primary lens 102. Furthermore, the secondary lens 302 is in a form of an axially oriented slab of dielectric material with an axial gradient index attached as a feed to the primary lens 102 within the cutout so that the axial orientation of the secondary lens 302 is aligned with an axis of the cylinder. In an example, a radial multi-GRIN-slab beam-former is allocated on the spherical surface of the primary lens 102, and a two-dimensional (2D) azimuth scanning can be obtained in dual polarization in a ±60° range without significant scan losses. Moreover, at the center of the secondary lens 302, the permittivity is the same as that at the focus of the primary lens 102, such as the smooth transition optimizes the impedance matching of the gradient-index lens 100.

FIG. 3B is a diagram of a gradient-index lens, in accordance with another embodiment of the present disclosure. FIG. 3B is described in conjunction with elements from FIGS. 1, 2, and 3. With reference to FIG. 3B, there is shown the gradient-index lens 100 that includes a primary lens 102 (of FIG. 1), a first sub-lens 306A, a second sub-lens 306B, a first beam port 308A, and a second beam port 308B. There is further shown a scale that represents permittivity variation ranges from 1 to 5 decibels (dB), with a step size of 0.4 dB.

In an embodiment, each of the secondary lenses includes axially stacked sub-lenses, each sub-lens being formed by an axially oriented slab of dielectric material with an axial gradient index and configured as a feed. In such embodiment, the gradient-index lens 100 can be manufactured in one molded part. Alternatively, it can be manufactured in slices which are stacked together and allow different heights (or different gain values). For example, a secondary lens (e.g., the secondary lens 302 of FIG. 3A) includes the first sub-lens 306A and the second sub-lens 306B, such as the second sub-lens 306B is axially stacked on the first sub-lens 306A. Moreover, the first sub-lens 306A and the second sub-lens 306B are formed by the axially oriented slab of dielectric material with an axial gradient index. Furthermore, the first sub-lens 306A includes the first beam port 308A and the second sub-lens 306B includes the second beam port 308B. In an example, more than one GRIN slab can be allocated and individually controlled, thus allowing for a scan in the elevation plane.

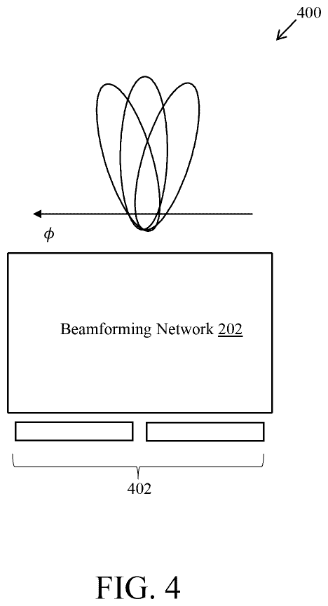

FIG. 4 is a diagram of a beam-forming network of a gradient-index lens, in accordance with an embodiment of the present disclosure. FIG. 4 is described in conjunction with elements from FIGS. 1, 2, 3A and 3B. With reference to FIG. 4 there is shown a diagram 400 of a beam forming network 202 of the gradient-index lens 100 of FIG. 1. In an embodiment, the gradient-index lens 100 includes radial thin slabs, which constitute the feeding network that includes beam ports 402 as shown in FIG. 4. The beam ports 402 are shown as per the degree of a radiation pattern that varies according to the value of theta, such as the radiation pattern includes a main beam and two side beams.

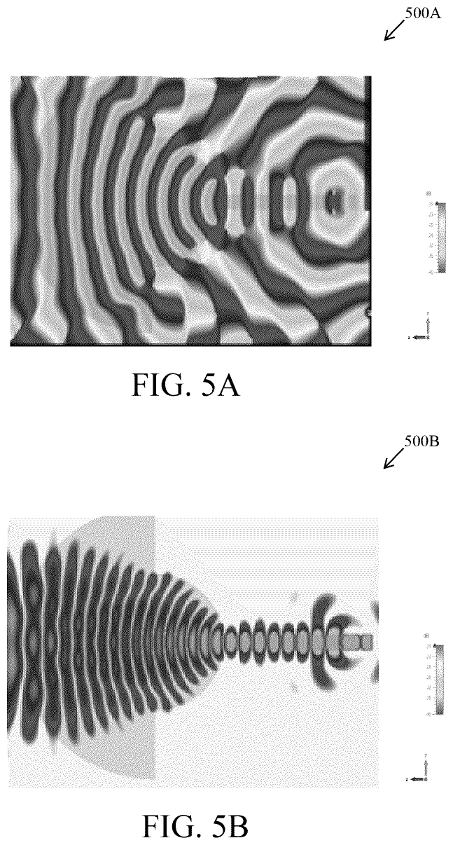

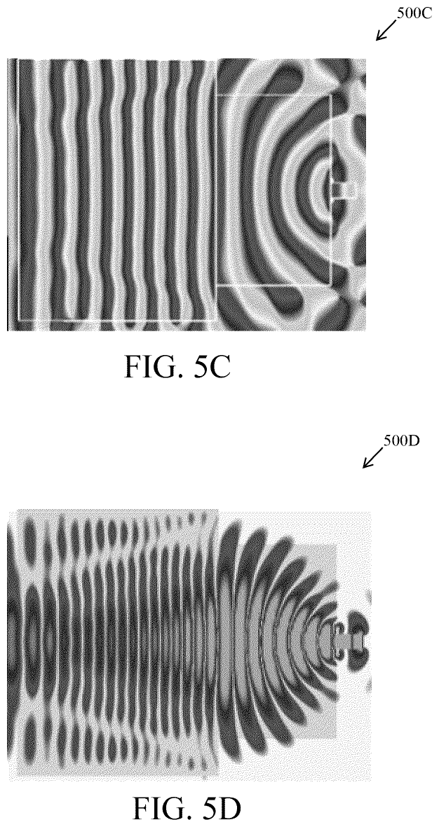

FIGS. 5A and 5B are graphical representations that illustrate phase and amplitude of a primary lens of a gradient-index lens, in accordance with different embodiments of the present disclosure. FIGS. 5A and 5B are described in conjunction with elements from FIGS. 1, 2, 3A, 3B, and 4. With reference to FIG. 5A, there is shown a graphical representation 500A that illustrates the phase of the primary lens 102 of the gradient-index lens 100 of FIG. 1. With reference to FIG. 5B, there is shown a graphical representation 500B that illustrates the amplitude of the primary lens 102 of the gradient-index lens 100 of FIG. 1. In an example, the phase is altered to obtain a plane wave at the output interface of the gradient-index lens 100.

FIGS. 5C and 5D are graphical representations that illustrate phase and amplitude of a microwave field in a secondary lens of a gradient-index lens, in accordance with different embodiments of the present disclosure. FIGS. 5C and 5D are described in conjunction with elements from FIGS. 1, 2, 3A, 3B, and 4. With reference to FIG. 5C, there is shown a graphical representation 500C that illustrates the phase in a secondary lens (e.g., the secondary lens 302 of FIG. 3A) of the gradient-index lens 100 of FIG. 1. With reference to FIG. 5D, there is shown a graphical representation 500D that illustrates the amplitude in the secondary lens of the gradient-index lens 100 of FIG. 1. In an embodiment, at the center of the secondary lens 302, the permittivity is the same as that at the primary lens 102 focus on which the secondary lens 302 is attached.

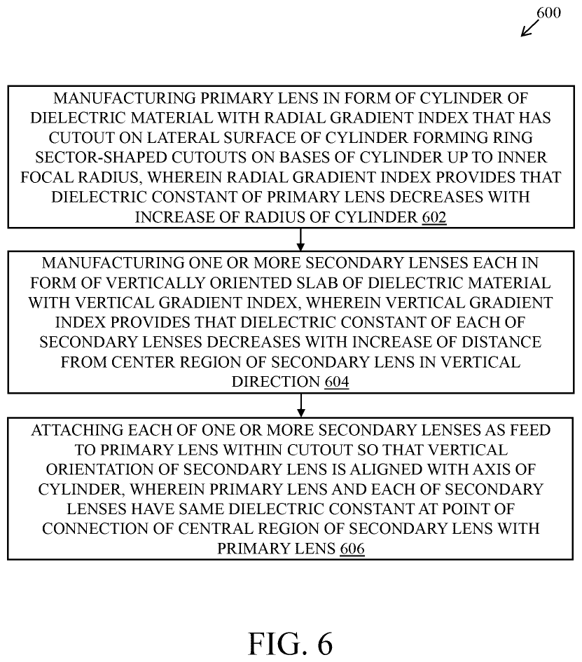

FIG. 6 illustrates a flow chart of a method of manufacturing a gradient-index lens, in accordance with an embodiment of the present disclosure. FIG. 6 is described in conjunction with elements from FIGS. 1, 2, 3A, and 3B. With reference to FIG. 6, there is shown a method 600 that includes operations 602 to 606.

At operation 602, the method 600 comprises manufacturing the primary lens 102 in a form of a cylinder of dielectric material with a radial gradient index, wherein the cylinder has a cutout on a lateral surface of the cylinder, the cutout has a ring-sector-shaped cross-sectional area. The cutout extends radially and axially. Radially it extends up to an inner focal radius in a radial direction. Axially it may extend along the entire height of the cylinder. The radial gradient index provides that a dielectric constant of the primary lens 102 decreases with an increase of a radius of the cylinder. In an example, Gutman graded index (GRIN) material is used as the dielectric material for manufacturing the primary lens 102 in the form of the cylinder, such as feeding elements of the primary lens 102 are also based on a flat GRIN lens setup, which is fully dielectric for improved impedance matching. In addition, the induced losses of the gradient-index lens 100 are low due to avoiding circuitry and the commercially available dielectric materials with low loss tangent. Moreover, the cutout emerges as a bulge-out structure from the cylinder, as shown in FIG. 1.

At operation 604, the method 600 comprises manufacturing the one or more secondary lenses 104A to 104K each in a form of an axially oriented slab of dielectric material with an axial gradient index. Moreover, the axial gradient index provides that a dielectric constant of each of the secondary lenses decreases with an increase of a distance from a center region of the secondary lens in the axial direction. In other words, each of the one or more secondary lenses 104A to 104K is manufactured in the form of the axially oriented slab and attached axially to the primary lens 102, such as each secondary lens is placed in a divergent position from another secondary lens. Beneficially, as compared to conventional approaches, the gradient-index lens 100 provides wide-angle scanning while maintaining a high gain radiation pattern without suffering from the scan loss effect.

At operation 606, the method 600 comprises attaching each of the one or more secondary lenses 104A to 104K as a feed to the primary lens 102 within the cutout so that the axial orientation of each of the secondary lens is aligned with an axis of the cylinder. Moreover, the primary lens 102 and each of the secondary lenses have the same dielectric constant at a point of connection of the central region of the secondary lens with the primary lens 102. In accordance with an embodiment, the primary lens 102 and the one or more secondary lenses 104A to 104K are manufactured by means of molding from a base material. Therefore, the primary lens 102, as well as each of the secondary lenses, can be manufactured together by making the use of the structure's symmetry for assembling purposes, due to which an improved prototyping can be achieved, such as by using three-dimensional printers.

In an embodiment, the primary lens 102 includes a molded part of the base material provided with holes in a first varying pattern to achieve the radial gradient index of the primary lens 102. In an example, a three-dimensional printer can be used to manufacture the molded part of the base material. In another embodiment, the primary lens 102 includes a set of axially stacked molded slices of the base material, each provided with holes in a first varying pattern to achieve the radial gradient index of the primary lens 102. Therefore, the gradient-index lens 100 can be manufactured in one molded part or in slices, which are later stacked together and allow different heights (or different gain values). In accordance with an embodiment, each of the secondary lenses comprises a molded slab of the base material provided with holes in a second varying pattern to achieve the axial gradient index of the secondary lens. Therefore, the gradient-index lens can be manufactured through a versatile and simplified manufacturing process. Beneficially, as compared to conventional approaches, the gradient-index lens 100 provides wide-angle scanning while maintaining a high gain radiation pattern without suffering from the scan loss effect.

The method 600 of manufacturing the gradient-index lens 100 provides a wide-angle scanning while maintaining a high gain radiation pattern without suffering from the scan loss effect. Moreover, the method 600 provides zero-focal length as well as the smooth dielectric transition between the one or more secondary lenses 104A to 104K and the primary lens 102 that leads to effective impedance matching. In addition, the induced losses of the gradient-index lens 100 are low due to avoiding circuitry and the commercially available dielectric materials with low loss tangent. The method 600 is used to manufacture the gradient-index lens 100 that supports wide bandwidth by the dielectric beamformer and is only limited by the feed radiating elements. Moreover, the input matching of the feeds of each of the secondary lenses is benefited from the smooth dielectric transition between different parts.

The modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the embodiments, which are, for brevity, described in the context of a single embodiment, may also be provided separately or in any suitable combination or as suitable in any other described embodiment of the disclosure.

What is claimed is:

1. A gradient-index lens, comprising:
a primary lens comprising a cylinder of dielectric material, wherein a dielectric constant in the cylinder decreases as a radial distance from an axis of the cylinder increases, wherein the cylinder includes a lateral surface and a cutout on the lateral surface, wherein the cutout includes a ring-sector-shaped cross-sectional area; and
one or more secondary lenses comprising a slab of dielectric material that extends radially from the primary lens within the cutout, wherein a dielectric constant in the slab decreases as an axial distance from a central region of the slab increases, and wherein the primary lens and each of the secondary lenses have the same dielectric constant at a point of connection of the central region of the slab of the secondary lens with the primary lens.

2. The gradient-index lens of claim 1, wherein the secondary lenses are attached to the primary lens within the cutout at different azimuthal positions.

3. The gradient-index lens of claim 1, wherein each of the secondary lenses is arranged to be fed with a respective microwave beam of one or more microwave beams and to feed the respective microwave beam further to the primary lens.

4. The gradient-index lens of claim 1, wherein each of the one or more microwave beams is dual-polarized.

5. The gradient-index lens of claim 1, wherein each of the secondary lenses comprises a plurality of axially stacked sub-lenses, wherein each of the sub-lenses comprises an axially extending slab of dielectric material, wherein a dielectric constant in the axially extending slab has an axial gradient.

6. The gradient-index lens claim 1, wherein the gradient-index lens is used in a multiple-input-multiple-output (MIMO) system.

7. A method of manufacturing a gradient-index lens, comprising:
providing a cylinder of dielectric material, wherein a dielectric constant in the cylinder decreases as a radial distance from an axis of the cylinder increases, wherein the cylinder includes a cutout on a lateral surface of the cylinder, and wherein the cutout includes a ring-sector-shaped cross-sectional area; and
attaching one or more slabs of dielectric material to the cylinder such that each of the slabs extends radially from the cylinder within the cutout, wherein a dielectric constant in the slab decreases as an axial distance from a central region of the slab increases,
wherein the cylinder and each of the slabs have the same dielectric constant at a point of connection of the central region of the slab with the cylinder.

8. The method of claim 7, further comprising forming the cylinder and the one or more slabs by molding.

9. The method of claim 7, wherein the cylinder further comprises a plurality of holes arranged in a first pattern such that the dielectric constant in the cylinder decreases as the radial distance from the axis of the cylinder increases.

10. The method of claim 7, wherein the cylinder further comprises a set of axially stacked molded slices, wherein each of the molded slices comprises a plurality of holes arranged in a first pattern such that the dielectric constant in the cylinder decreases as the radial distance from the axis of the cylinder increases.

11. The method claim 7, wherein each of the slabs comprises a plurality of holes arranged in a second pattern such that the dielectric constant in the slab decreases as the axial distance from the central region of the slab increases.

12. A multiple-input-multiple-output (MIMO) system, comprising:
a gradient-index lens, wherein the gradient-index lens comprises:
a primary lens comprising a cylinder of dielectric material, wherein a dielectric constant in the cylinder decreases as a radial distance from an axis of the cylinder increases, wherein the cylinder includes a lateral surface and a cutout on the lateral surface, wherein the cutout includes a ring-sector-shaped cross-sectional area; and
one or more secondary lenses comprising a slab of dielectric material that extends radially from the primary lens within the cutout, wherein a dielectric constant in the slab decreases as an axial distance from a central region of the slab increases, and wherein the primary lens and each of the secondary lenses have the same dielectric constant at a point of connection of the central region of the slab of the secondary lens with the primary lens.

13. The MIMO system of claim 12, wherein the secondary lenses are attached to the primary lens within the cutout at different azimuthal positions.

14. The MIMO system of claim 12, wherein each of the secondary lenses is arranged to be fed with a respective microwave beam of one or more microwave beams and to feed the respective microwave beam further to the primary lens.

15. The MIMO system of claim 12, wherein each of the one or more microwave beams is dual-polarized.

16. The MIMO system of claim 12, wherein each of the secondary lenses comprises a plurality of axially stacked sub-lenses, wherein each of the sub-lenses comprises an axially extending slab of dielectric material, wherein a dielectric constant in the axially extending slab has an axial gradient.
